(19) United States
(12) Patent Application Publication
(10) Pub. No.: US 2025/0279272 A1
(43) Pub. Date: Sep. 4, 2025

(54) SEQUENTIAL PASS EXPRESS CHARGE DETECTION MASS ANALYZER

(71) Applicant: THE REGENTS OF THE UNIVERSITY OF CALIFORNIA, Oakland, CA (US)

(72) Inventors: Evan R. Williams, Oakland, CA (US); Conner C. Harper, Albany, CA (US)

(73) Assignee: THE REGENTS OF THE UNIVERSITY OF CALIFORNIA, Oakland, CA (US)

(21) Appl. No.: 19/193,915

(22) Filed: Apr. 29, 2025

Related U.S. Application Data
(63) Continuation of application No. PCT/US2023/081348, filed on Nov. 28, 2023.
(60) Provisional application No. 63/385,146, filed on Nov. 28, 2022.

(51) Int. Cl. H01J 49/02; H01J 49/42

(52) U.S. Cl. CPC H01J 49/025; H01J 49/426

(57) ABSTRACT

A sequential pass express charge (e) detection (SPEeD) mass analyzer designed for highly sensitive, rapid mass measurements of high mass (>1 MDa) analytes. A SPEeD analyzer enables high throughput and sensitivity because ions merely need to pass through the series of detectors a single time for a mass measurement to be made.

### CROSS-REFERENCE TO RELATED APPLICATIONS

This application claims priority to, and is a 35 U.S.C. § 111 (a) continuation of, PCT international application number PCT/US2023/081348 filed on Nov. 28, 2023, incorporated herein by reference in its entirety, which claims priority to, and the benefit of, U.S. provisional patent application Ser. No. 63/385,146 filed on Nov. 28, 2022, incorporated herein by reference in its entirety. Priority is claimed to each of the foregoing applications.

The above-referenced PCT international application was published as PCT International Publication No. WO 2024/118604 A1 on Jun. 6, 2024, which publication is incorporated herein by reference in its entirety.

### STATEMENT REGARDING FEDERALLY SPONSORED RESEARCH OR DEVELOPMENT

Not Applicable

### NOTICE OF MATERIAL SUBJECT TO COPYRIGHT PROTECTION

A portion of the material in this patent document may be subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND

### 1. Technical Field

This technology pertains generally to methods and devices for mass spectrometry and more particularly to methods and devices for sequential pass, express charge detection mass spectrometry. The apparatus enables mass measurements of individual ions at rates greater than 10,000 ions per second, which is approximately 1000 times faster than current state-of-the-art charge detection mass spectrometry instrumentation and methods that measure molecules greater than 1 MDa in size.

### 2. Background Discussion

Mass spectrometry (MS) is a powerful method for biomolecule characterization. Gas-phase biomolecular ions can be directly formed from solution using electrospray ionization (ESI) and analyzed using a variety of MS techniques. Analysis of intact biomolecules by MS, often termed ‘native MS’, has become an important tool in the arsenal of analytical techniques in structural biology.

For a few highly purified, highly homogeneous samples, such as viral capsids, modified commercial MS instrumentation has had limited success with larger analytes reaching up to approximately 20 MDa. Even when successful mass measurements are made for MDa-sized analytes, dynamic range suffers as a consequence of the increased heterogeneity because broadened peaks obscure low abundance components. Large particles or collections of particles (such as whole cells) can be weighed using sensitive surface acoustic wave sensors (SAWS) with a lower limit of few picograms, corresponding to a few teradaltons (TDa). However, this leaves a significant gap from ˜10 MDa to ˜ 1 TDa that is inaccessible using currently available commercial instrumentation capable of accurate mass measurements.

Charge detection mass spectrometry (CDMS) effectively bridges the gap in mass measurement technologies and is well suited to the analysis of aerosol-borne viruses and even bacteria such as tuberculosis. CDMS systems can provide mass measuring accuracies for ions with masses above 500 kDa that are comparable to more expensive conventional instruments. There is a need for technology that can be applied to ions that are too large (10+ MDa) or heterogeneous to measure using conventional MS systems. Single pass CDMS instruments have been used to measure masses of large polymers, nanodroplets, dust, and bacterial spores. Mass measurements of MDa-sized PEG molecules and polystyrene nanoparticles (50 nm to 110 nm in diameter) using an array of 4 detection tubes positioned between the trapping electrodes of an electrostatic ion trap (EIT) have been previously reported. However, no commercial CDMS instrumentation yet exists that can measure masses in the range of 10's to 1000's of MDa.

### BRIEF SUMMARY

Methods and devices are provided for a sequential pass express charge (e) detection (SPEeD) mass analyzer designed for highly sensitive, rapid mass measurements of high mass (>1 MDa) analytes. A SPEeD analyzer enables high throughput and sensitivity because ions merely need to pass through the series of detectors a single time for a mass measurement to be made.

Measurements using the SPEeD analyzer are facilitated by efficient upstream optics that first thermalize and then accelerate ions to a well-defined kinetic energy for improved measurement accuracy and simplicity. This innovative combination of instrumental elements will make it possible to take advantage of the ‘perfect’ sensitivity inherent to individual ion measurements in charge detection mass spectrometry (CDMS). For example, making quantitative counts of pathogens contained in aerosols will be possible, i.e., every pathogen particle that enters the SPEeD will be detected and counted.

The presented technology enables mass measurements of individual ions that are greater than about 1 MDa in size at rates that exceed approximately 10,000 ions per second. In one embodiment, the technology utilizes an ion acceleration region prior to the detection region that kinematically compresses the energy distribution of ions prior to mass analysis, resulting in lower measurement errors and removes the need for individual ion energy determination or filtering. The technology also incorporates a unique data analysis methodology that is enabled by the interweaved physical configuration of the detector electrodes connected to two separate but correlated signal channels.

Because virtually every large analyte ion with >˜100 e that reaches the SPEeD will be counted and measured, measurements of 10,000+ ions per second are possible, while still retaining measurement resolution commensurate with the natural heterogeneity of the sample when the ion current can support this acquisition rate. The higher sensitivity inherent to a single-pass analyzer enables SPEeD measurements allow one to quantitatively profile the pathogen content of aerosols in the duration of a single, typical human breath (1 to 3 seconds). In this application, achieving a sufficient analyte ion current may be the limiting factor in measuring a statistically robust number of ions. However, longer measurement periods (10 to 30 seconds) could be used to increase counts and decrease limits of detection (LOD) and still be practical for real-time screening purposes as long as background counts from particulates and other interferences are low and do not accumulate significantly. It is worth noting that even if the LODs achieved would only allow detection and identification of pathogen loads from high-emitting individuals, screening with a device incorporating the SPEeD analyzer would still be meaningful because highly contagious individuals who are most likely to contribute to the spread of disease could be rapidly identified.

Additional applications of the SPEeD analyzer may include quantifying particulate content in air, fast quality assurance testing of virus-like particles, polymers, nanoparticle structures, and other macromolecular complexes with masses >1 MDa.

Further aspects of the technology described herein will be brought out in the following portions of the specification, wherein the detailed description is for the purpose of fully disclosing preferred embodiments of the technology without placing limitations thereon.

### BRIEF DESCRIPTION OF THE DRAWINGS

The technology described herein will be more fully understood by reference to the following drawings which are for illustrative purposes only:

FIG. 1 is a functional block diagram of a method for sequential pass express charge (e) detection of ionized sample analytes according to one embodiment of the technology.

FIG. 2 is a schematic diagram of a sequential pass express charge (e) detection (SPEeD) mass analyzer apparatus according to the technology of this disclosure.

FIG. 3 is a plot of a time domain signal for a single PEG ion with a charge of ˜630 e and mass of 8 MDa repeatedly passing through a detector tube in an EIT-CDMS instrument shown in FIG. 2.

FIG. 4 is a plot of CDMS mass spectra of AAV capsids (3.7 MDa) and AAV virions (4.7 MDa) trapped for 100 ms.

FIG. 5 is a plot of CDMS mass spectra of AAV capsids (3.7 MDa) and AAV virions (4.7 MDa) trapped for 500 ms.

FIG. 6 is a plot of CDMS mass spectra of AAV capsids (3.7 MDa) and AAV virions (4.7 MDa) trapped for 5000 ms. Resolution (R) increases with period length until the inherent heterogeneity of AAV becomes the dominant contributor to peak width, limiting mass resolution to a maximum of ˜65.

### DETAILED DESCRIPTION

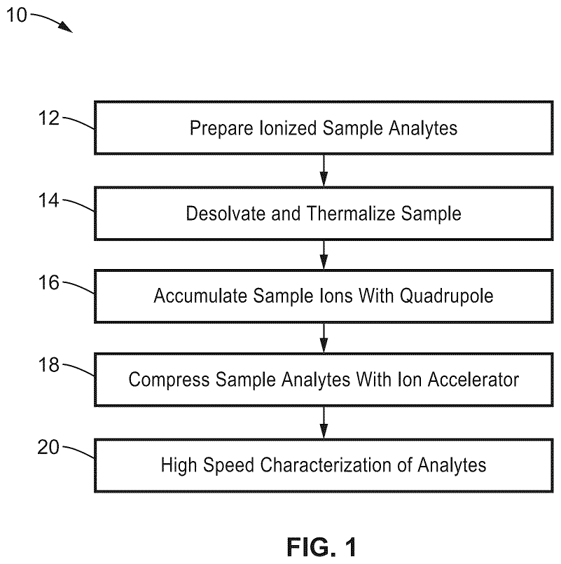

Referring more specifically to the drawings, for illustrative purposes, apparatus, systems and methods for high-speed characterization of ionized analytes with a sequential pass express charge (e) detection (SPEeD) mass analyzer apparatus are generally shown. Several embodiments of the technology are described generally in FIG. 1 to FIG. 6 to illustrate the characteristics and functionality of the apparatus, systems, materials and methods. It will be appreciated that the methods may vary as to the specific steps and sequence and the systems and apparatus may vary as to structural details without departing from the basic concepts as disclosed herein. The method steps are merely exemplary of the order that these steps may occur. The steps may occur in any order that is desired, such that it still performs the goals of the claimed technology.

Turning now to FIG. 1, one embodiment of a method 10 for sequential pass express charge (e) detection is shown schematically. The first step of method 10, shown at block 12, is to prepare an ionized sample or flow of ionized samples of interest. The samples may be ionized by a method for producing a distribution of highly charged analytes such as electrospray ionization (ESI), extractive ESI (ESSI), desorption ESI (DESI), cold plasma ionization, sonic spray ionization, paper spray ionization, thermospray ionization, ultraviolet (UV) photoionization, and other ionization techniques.

The highly charged sample analytes prepared at block 12 are then desolvated heated at block 14, preferably with a heated inlet and an ion funnel to yield gas phase analyte ions. Unevaporated solvent from analyte ions can result in mass errors and greater mass uncertainty. Unevaporated solvent droplets that do not contain analytes can also be a source of background noise.

Optionally, the flow of desolvated ions of the sample that are produced at block 14 are then accumulated with a quadrupole at block 16. In this embodiment, the ions are thermalized further and accumulated by the quadrupole which is then emptied to form an ion pulse.

At block 18, the energy bandwidth of ions from the quadrupole is compressed at block 18, preferably with an ion accelerator. The compression at block 18 to a relatively narrow range of ion energies improves the m/z measurements of the mass spectrometer and acquisition time and allows high speed characterization of the analytes at block 20.

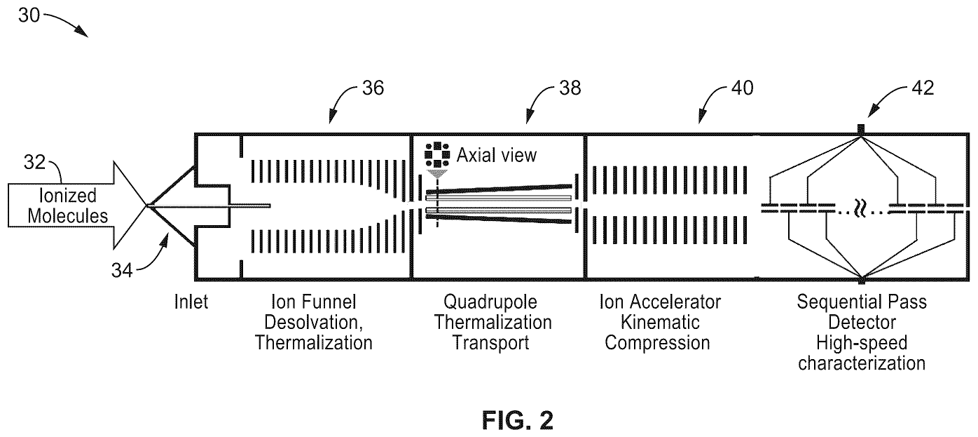

One embodiment of an apparatus 30 for performing the detection and characterization methods is shown schematically in FIG. 2. Sample analytes are prepared and characterized by the mass spectrometer instrument in multiple stages. In the first stage, a sample of interest will be ionized by any technique that produces a distribution of highly charged analytes, including, but not limited to, electrospray ionization (ESI), extractive ESI (ESSI), desorption ESI (DESI), cold plasma ionization, sonic spray ionization, paper spray ionization, thermospray ionization, ultraviolet (UV) photoionization, and other ionization techniques. The ionized sample molecules 32 will enter the CDMS instrument at the inlet 34.

In the second stage, the ionized sample 32 will pass through a preferably heated inlet 34 to an ion funnel 36. The ion funnel 36 and heated inlet 34 will perform any needed desolvation of analytes to yield gas phase analyte ions. An ion funnel 36 is capable of nearly 100% efficient ion transmission, improving downstream sensitivity. Unevaporated nanodroplets and highly solvated ions can contribute significant background chemical noise and skew mass measurements. However, the ability to select high inlet temperatures (up to 300° C.) and an appropriate choice of ion funnel voltage gradient and chamber pressure (˜2 Torr) ensures complete desolvation while simultaneously thermalizing the gas-phase analyte ions. Ion thermalization is desirable because the velocity slip of particles entering the instrument is cross-section dependent and larger particles gain a significant kinetic energy “boost” relative to smaller particles, as has been observed in previous CDMS measurements of 50-110 nm polystyrene nanospheres. This “boost” can be accounted for using calibration with standards of known cross-section. However, the greater spread of ion energies inherent to unthermalized ions will increase the uncertainty of mass-to-charge ratio (m/z) if not addressed prior to detection (Eq. 1 and Eq. 2). The value m/z is determined from a preset ion energy E and velocity v (eq. 2) measured via the temporal width of the induced charge pulses generated by ions passing through a detector electrode of known length.

$$\frac{m}{z} = \frac{C ( E )}{{f}^{2}} \qquad ( 1 )$$

$$\frac{m}{z} = \frac{2 E}{{v}^{2}} \qquad ( 2 )$$

The second instrument stage may be omitted or substituted for other thermalizing ion optics in other embodiments of the presented technology.

In the third stage, ions transit from the ion funnel 36 output to a quadrupole 38 can be equipped with asymptotic guide rods spanning three stages of differential pumping with pressures ranging from 1×10⁻² down to ˜1×10⁻⁴ Torr in this embodiment. The received ions will be further thermalized during the transit of the quadrupole and the asymptotic guide rods, when supplied with a DC offset, generate a gentle “downhill” potential gradient in the center of the quadrupole to prevent ions from stalling. In addition to thermalization in this lower pressure regime, the quadrupole 38 can serve as an ion accumulation region that can be rapidly emptied to produce a pulse of ions. This instrument stage may be omitted or substituted for other thermalizing ion optics in other embodiments of the presented technology.

Note that the ion funnel 36 and quadrupole 38 stages are optional, but beneficial and preferred. Also, the apparatus will function with either an ion funnel stage 36 or a quadrupole stage 38, or both.

In the fourth stage, a ˜1 kV ion accelerator (˜1×10⁻⁶ Torr) 40 will kinematically compress any remaining spread of ion energies into a relatively narrow energy range. This is an important aspect of the technology because it removes the need for complicated energy bandwidth-selective ion optics, such as turning quadrupoles or hemispherical dual analyzers, that are normally used in other CDMS instruments and that significantly reduce sensitivity. The energy bandwidth of ions after thermalization in a quadrupole 38 is approximately ˜1-2 eV/z. Using an acceleration gradient of ˜1 kV therefore kinematically compresses this bandwidth of energies to just ˜0.1-0.2% of the total ion energy and makes it possible to approximate all ion energies at ˜1 kV/z with low error. Because m/z measurements depend on ion energy (Eq. 1 and Eq. 2), this compression with the ion accelerator 40 decreases the uncertainty of the ion m/z measurement. The narrowest bandwidth demonstrated in previous CDMS work using an electrostatic ion trap and energy filtering ion optics achieved an energy bandwidth of ˜0.3% of the nominal ion energy but also came at the cost of significantly reduced sensitivity. The increased ion energies/velocities inherent to this accelerator 40 also reduces transit times in the detector stages 42 and thereby decreases the required acquisition times. The pressure and voltage parameters used in this instrument stage can be freely varied in various embodiments of the presented technology. Another important features is the coupling of this kinematic compression stage to a subsequent SPEeD mass analyzer stage.

In the fifth stage, the accelerated ions transit the SPEeD mass analyzer 42, composed of a multiplicity of detector tubes (n ≥2) ˜1 cm in length in this embodiment. The high maximum ion acquisition speed that is made possible by the SPEeD configuration (10,000+ individual ions/s) makes it an important feature of the apparatus. EITs necessarily spend much of their time “closed”, as ions must oscillate back and forth inside a potential well to produce a signal. Ions that are incident to the trap during this time must be stored or otherwise wasted, decreasing sensitivity and lengthening measurement times.

Unlike EITs, the SPEeD can continuously analyze an ion beam because ions only transit the detector tubes once or twice, in the case where a single ion reflection is utilized. For example, ions accelerated to 1 kV/z transit the tubes in approximately 100 us to 300 us depending on the ion m/z (30,000-300,000), making about 4,000 to 12,500 non-overlapping measurements of individual ions possible each second. In contrast, only a few ions per second are typically measured in EIT-CDMS, although multiplexing can improve measurement speed to some extent. The speed of the SPEeD can potentially be improved further because it is possible to distinguish and measure the masses of ions with partially overlapped signals.

The detector tubes of the SPEeD can be alternately wired to two detection channels, as shown in FIG. 2. This configuration results in ion signals that resemble a 50% duty cycle square wave with the two detection channels 180° out of phase. The signals can be analyzed individually and compared to confirm a positive identification of an analyte ion using time domain triggering threshold methods.

In other embodiments, different wiring configurations to produce other duty cycle and phase relationships between the two channels can also be utilized to produce unique signal patterns that can be used to confirm a positive identification of an analyte ion. Moreover, more than two detection channels can be used to produce additional unique duty cycle and phase relationships between each channel signal that can also be used to confirm a positive identification of an analyte ion.

Alternative analysis methods for analyzing two or more channels using cross-correlation may also be used to improve detection. Cross-correlation is used because the signals from the two or more channels can be configured to be highly similar and to be only differentiated by phase. The quality of this cross-correlation analysis for ion signals improves with the number of detector electrodes because a greater number of cycles in the two or more signals being compared results in higher absolute values of correlation coefficients. Correlation and anti-correlation peaks corresponding to partial in-phase and out-of-phase overlaps of the two or more signal pulse trains appear at time delays at multiples of the tube transit time where the multiplier is the number of channels. The time delay at which the overall maximum correlation coefficient occurs corresponds to full overlap of the two signal pulse trains. This time delay can be used to determine the time a particular ion entered the detector array with high accuracy, even when other signal pulse trains are simultaneously being generated by other ions within the array. This makes it possible to track and analyze multiple ions that are in the SPEeD simultaneously for faster, more efficient measurements. The velocity (and therefore the m/z) of each ion can be derived from the time delay of maximum correlation because this time directly corresponds with the time required to transit a single tube and the length of the detector tube is known.

Autocorrelation analyses of a single data channel have been performed previously for a multi-detector array, but grounded elements were interweaved between detector electrodes so that a square wave-like signal amenable to a correlation approach could be generated. The cross-correlation method described here represents a significant advance relative to autocorrelation methods because all tubes of an interweaved set can be used as detection electrodes instead of just half, resulting in more measurements of the ions of interest and higher S/N for both ion m/z (via time delay/velocity) and charge (via amplitude) in an array of given length. These measurements of both m/z and charge are used to calculate the mass of each ion that transits the SPEeD analyzer.

Additionally, because the cross-correlation approach allows the true ion entrance times to be directly determined from the characteristics of the correlation plot, uncertainty caused by ions that are simultaneously transiting the array with different timings and velocities is significantly reduced. Because multiple ions can simultaneously transit the array and still be accurately measured, a greater current of ions can be introduced into the detector and a higher number of ions can be analyzed within a given time period.

Another alternative analysis method, not used in previous charge detector arrays, uses one of two alternately wired detection channels is inverted. The inverted channel and non-inverted channel are then connected to the inputs of a differential amplifier. Because of the inherent 50% duty cycle and 180° out of phase relationship between the two channels, this differential amplification results in a single signal with a duty cycle of 50% but with an amplitude that is twice that of the signals in the two channels. This effective addition of the two channel signals results in a maximum of in only a sqrt (2) increase in the RMS noise of the signal, yielding a minimum sqrt (2) overall improvement in the signal to noise ratio (S/N).

Differential amplification also has the added benefit of common mode noise rejection. The geometry and proximity of the two sets of alternating detector tubes means that discrete, or persistent noise signals experienced are similar and produce a similar signal on both sets of detector tubes and therefore are largely eliminated by differential amplification. This results in fewer spectral interferences for real ions and more consistent S/N ratios across a broad range of ion velocities. This common mode noise rejection also makes time domain-based ion detection triggering thresholds more reliable, as discrete noise signals that could otherwise produce erroneous triggering events that do not correspond to the passage of an ion are greatly reduced. A final benefit of this analysis method is that it reduces the two initial signal channels to a single channel, simplifying subsequent analysis steps and enabling different types of signal analysis approaches such as the autocorrelation approach which has been used previously.

One alternative signal analysis method is based on the use of short-time Fourier transforms (STFT). In general, the signal produced by a differential amplifier from the two alternatively wired detector tube channel configuration with one channel inverted resembles a 50% duty cycle square wave and is periodic, making it amenable to Fourier transform-based analysis. In this detector tube configuration, the frequency of an ion signal in Fourier transform analysis is directly related to the ion velocity and amplitude at that frequency is proportional to the ion charge. Thus, these parameters can be used to calculate the ion mass if ion energy is known, as shown in eq. 2. However, the length of the time domain signal to be transformed should match the length of time required by an ion to pass through all of the detector tubes as closely as possible to yield the highest precision in the frequency and amplitude measurements. Transforms of longer time periods result in the addition of noise without any additional signal, resulting in decreased S/N. However, the exact velocity of a given ion cannot be known prior to its entry into the detector tubes. To address this, a STFT with a time segment length comparable to the range of expected ion transit times and that is stepped across the time domain signal by an increment that is less than or equal to one half of the segment length. For example, for ions with m/z ˜300,000, a 300 μs Fourier transform segment would be used and stepped across the time domain signal in increments of <150 μs. This overlapping STFT analysis is advantageous because inevitably ion signals will occur such that they span two different Fourier transform segments. However, the overlapping segments ensure that most of the ion signal will be contained in a single segment, making it possible to detect ions with fewer charges than the direct time domain LOD. The relative amplitudes of segments containing a part of an ion signal will also allow the time of the ion entrance and exit from the detector array to be localized and an additional FT with a matched segment length to be performed on the portion of the time domain signal containing the ion signal.

Alternatively, localizing the ion signal in the time domain can also allow the autocorrelation procedures described above to be applied directly to the time domain signal for further improvements in S/N. This STFT analysis can be performed in real-time on a continuously streamed signal, enabling real-time feedback on ion masses and charges. This STFT analysis method is not limited to use on the differentially amplified signal but can also be applied to the signal produced by any single channel output of the detector array.

In yet another alternative analysis method, time domain signals are analyzed using methods based on filter diagonalization. Similar to STFT-based methods, the ion frequencies and amplitudes produced by these methods would correspond to the ion velocities and charges, respectively. One advantage of using filter diagonalization methods is that frequencies can be determined with higher precision than is possible using STFT analyses, potentially making it possible to determine the ion velocity with greater precision. However, filter diagonalization-based techniques are computationally intensive and require a relatively high S/N for stable performance.

The high throughput of the SPEeD apparatus necessarily comes at the cost of measurement quality because SPEeD charge uncertainties and charge limits of detection (zLOD) are much higher than those achievable using EIT-based CDMS instruments. Using an EIT, individual ion charge uncertainties as low as ˜0.2 e and an LOD of a single charge have been achieved. Energy selective ion optics have been used to admit a bandwidth as narrow as 0.3% of the nominal ion energy and, combined with EIT designs aimed at reducing the effect of ion energy on the m/z measurement, resolutions of up to ˜330 have been demonstrated.

The highest performing multi-detector instrument to date utilized amplitude averaging over two sets of 11 detector tubes and was able to achieve a charge uncertainty of ˜10 e and an zLOD of ˜100 e. The uncertainty in charge was thus estimated at worst to be ˜10%, improving linearly with the increased charge of the analyte. To determine the m/z of each individual ion, the signals from two electrically isolated sets of 11 tubes with a 1 V potential difference between them were compared and the shift in velocity was measured, a method distinct from the method employed by the SPEeD analyzer. Conservation of energy allows the m/z to be determined from this velocity shift, but the error in this measurement was high (˜15%) for smaller ions and degraded further for larger ions that had smaller velocity shifts. The combined uncertainty in mass from the charge and m/z ranged from ˜10-15% depending on the size of the molecule, corresponding to a mass resolution of approximately 7-10.

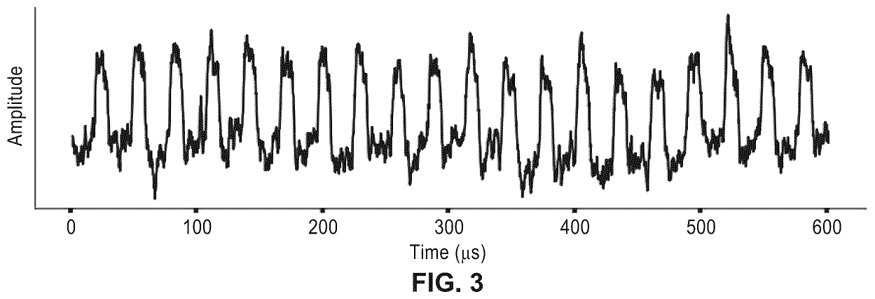

The scaling of CDMS measurement precision and molecular heterogeneity with size largely negates the need for EIT-level precision for the large analytes targeted by the SPEeD analyzer. In all CDMS experiments, S/N increases as the charge of the analyte increases because charge error is predicated on baseline electronic noise in the measurement and the length of the measurement period but does not depend on the analyte itself. Because large ions, such as aerosol-borne viruses, can carry a high number of charges (˜125-4000 e), the charge precision necessary to meet a specified standard is decreased relative to smaller, lower charge ions. The range of charges spanned by these large ions is sufficiently high that the masses of all ions that reach the detector will be obtained. For example, FIG. 3 shows a 600 μs segment of data for a single PEG ion with a mass of ˜8 MDa and a charge of ˜630 e measured in an EIT-CDMS instrument. The 20 high amplitude pulses corresponding to the passage of the ion through the conductive tube are easily distinguishable and illustrate the extent of signal averaging possible with the SPEeD analyzer with 20 detection tubes using similar charge sensitive pre-amplifiers. In a SPEeD analyzer, the higher velocities imparted by the acceleration region will compress the measurement to shorter time periods (e.g. 100-300 μs) but will be readily measurable.

Multiple detector array instruments have received significantly less attention and optimization compared to EIT-based CDMS instruments. The SPEeD analyzer incorporates new methods and physical configurations that constitute a meaningful advance over the previous state-of-the-art in large molecule analysis. One key aspect of the SPEeD analyzer is the generation of a narrow ion energy bandwidth by kinematic compression. For example, thermalized ions (1-2 eV/z energy spread) will be accelerated by a ˜ 1 kV potential, essentially generating a monoenergetic ion beam. Because ion energies are well-defined in this configuration, ion m/z's can be directly determined from the measured ion velocity (eq. 2) instead of an ion velocity shift measured between sets of detector tubes with offset potentials, a differentiating aspect from previous art. Velocity alone can be measured with significantly higher precision, with an uncertainty of 1.4% demonstrated for an 11-tube instrument. This represents an approximately 10-fold improvement in m/z precision over previous detector array measurements. Removing the need for a potential offset also eliminates a source of noise in the charge measurement as all tubes can referenced to the same potential (ground). The ˜1 kV acceleration also compresses the trajectories of ions leaving the upstream quadrupole into a narrow beam. By limiting the diffusive spreading of ions perpendicular to the axis of the SPEeD, more ions will transit the entire length of the SPEeD, improving sensitivity.

The technology described herein may be better understood with reference to the accompanying examples, which are intended for purposes of illustration only and should not be construed as in any sense limiting the scope of the technology described herein as defined in the claims appended hereto.

### Example 1

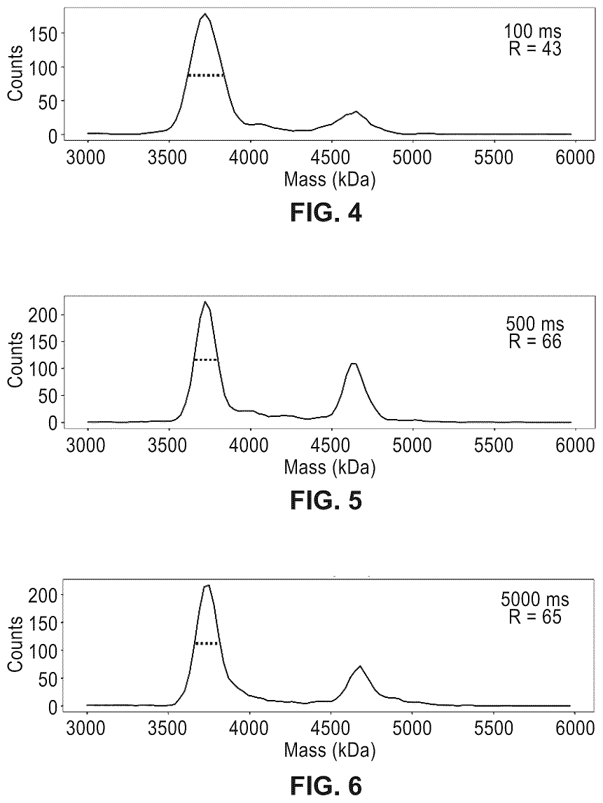

To illustrate the functionalities and capabilities of apparatus and methods, the CDMS apparatus was applied to a vector used in gene therapy research, where genetic material is introduced into cells to compensate for abnormal genes that cause disease using viral vectors for delivery. Recombinant adeno-associated viruses (AAVs) are promising vectors for gene therapy, but conventional methods used to evaluate AAVs, and the incorporation of the genetic payload have low resolution and require significant time and effort. In contrast, CDMS has been shown to resolve AAV particle diversity relatively quickly, including demonstrating that the empty/full capsid ratio can be determined in approximately 2 minutes as illustrated in FIG. 4.

As is the case for conventional MS, the maximum mass resolution achievable by CDMS can ultimately become limited by sample heterogeneity. Not only does the absolute heterogeneity of macromolecules increase with increased masses, but the relative heterogeneity increases as well. In other words, as analyte mass increases, the proportion of the peak width to the nominal mass also grows, decreasing the achievable mass resolution.

Preliminary data from current research on adeno-associated viruses (AAVs) demonstrate this principle of sample limited mass resolution in CDMS and are shown in FIG. 4 through FIG. 6. A sample of AAVs, with an empty capsid population weighing ˜3.7 MDa and a genome-containing virus population at ˜4.7 MDa were analyzed using our existing CDMS instrument with different ion trapping period lengths. Two thousand individual ions were analyzed at each period length. As the length of the ion trapping period is increased, the greater extent of signal averaging that is possible results in narrower peaks and improved mass resolution that should scale as the square root of the measurement time. FIG. 4, FIG. 5 and FIG. 6 shows that increasing the trapping period from 100 ms in FIG. 4 to 500 ms in FIG. 5 results in a noticeable decrease in peak width (dashed lines) and increased mass resolution (R). However, after reaching a value of 66 in FIG. 5, the resolution does not improve even when a trapping period of 5000 ms (FIG. 6) is used, indicating that the measurement uncertainty of the instrument at the longer trapping times of FIG. 5 and FIG. 6 does not significantly contribute to the peak width observed. The peak width at these longer times is therefore due to the heterogeneity of the sample. This sample limited resolution of ˜65 is similar to that observed in AAV mass spectra reported by others using CDMS and Orbitrap-based individual ion measurement techniques, providing further compelling evidence that the limited resolution of the AAV samples is due to intrinsic unresolvable heterogeneity and not a result of the measurement method.

From the description herein, it will be appreciated that the present disclosure encompasses multiple implementations of the technology which include, but are not limited to, the following:

A sequential pass express charge (e) detection (SPEeD) mass analyzer apparatus, comprising: (a) an inlet configured to receive a flow of ionized sample analytes; (b) an ion accelerator stage downstream of the inlet, the ion accelerator stage configured for kinematic compression of the ionized analytes; and (c) a SPEeD mass analyzer stage downstream of the ion accelerator stage, the SPEeD mass analyzer stage configured for high-speed characterization of the ionized analytes.

The apparatus of any preceding or following implementation, wherein the sample is ionized by a method for producing a distribution of highly charged analytes selected from the group consisting of electrospray ionization (ESI), extractive ESI (ESSI), desorption ESI (DESI), cold plasma ionization, sonic spray ionization, paper spray ionization, thermospray ionization, and ultraviolet (UV) photoionization.

The apparatus of any of preceding or following implementation, wherein the analytes are selected from the group consisting of molecules, molecular assemblies, particles, intact cells, and other large analytes.

The apparatus of any preceding or following implementation, further comprising an ion funnel stage downstream of the inlet and upstream of the ion accelerator stage, the ion funnel stage configured for desolvation and thermalization of the ionized analytes.

The apparatus of any preceding or following implementation, further comprising a quadrupole stage downstream of the ion the inlet and upstream of the ion accelerator stage, the quadrupole stage configured for thermalization and transport of the ionized analytes.

The apparatus of any preceding or following implementation, further comprising: an ion funnel stage downstream of the inlet and upstream of the ion accelerator stage, the ion funnel stage configured for desolvation and thermalization of the ionized analytes; and a quadrupole stage downstream of the inlet and upstream of the ion accelerator stage, the quadrupole stage configured for thermalization and transport of the ionized analytes.

The apparatus of any preceding or following implementation, wherein the SPEeD mass analyzer stage comprises a plurality of detector tubes alternately connected to two or more detection channels, and wherein the two or more detection channels are analyzed using cross-correlation to make velocity, charge, and mass measurements of an analyte ion.

The apparatus of any preceding or following implementation, wherein the SPEeD mass analyzer stage comprises a plurality of detector tubes alternately connected to two detection channels; and wherein one of the two detection channels is inverted; and wherein the inverted and non-inverted channels are connected to the inputs of a differential amplifier to yield an increase signal-to-noise ratio and to greatly decrease common mode noise.

The apparatus of any preceding or following implementation, wherein the SPEeD mass analyzer stage comprises a plurality of detector tubes wherein one or more detection channels are analyzed using short-time Fourier transform (STFT) analysis methods to make ion velocity, charge, and mass measurements of an analyte ion.

The apparatus of any preceding or following implementation, wherein the SPEeD mass analyzer stage comprises a plurality of detector tubes wherein one or more detection channels are analyzed using filter diagonalization analysis methods to make ion velocity, charge, and mass measurements of an analyte ion.

A sequential pass express charge (e) detection (SPEeD) mass analyzer apparatus, comprising: (a) an inlet configured to receive a flow of ionized sample analytes; (b) an ion funnel stage downstream of the inlet, the ion funnel stage configured for desolvation and thermalization of the ionized analytes; (c) an ion accelerator stage downstream of the ion funnel stage, the ion accelerator stage configured for kinematic compression of the ionized analytes; and (d) a SPEeD mass analyzer stage downstream of the ion accelerator stage, the SPEeD mass analyzer stage configured for high-speed characterization of the ionized analytes.

The apparatus of any preceding or following implementation, wherein the sample is ionized by a method for producing a distribution of highly charged analytes selected from the group consisting of electrospray ionization (ESI), extractive ESI (ESSI), desorption ESI (DESI), cold plasma ionization, sonic spray ionization, paper spray ionization, thermospray ionization, and ultraviolet (UV) photoionization.

The apparatus of any preceding or following implementation, wherein the SPEeD mass analyzer stage comprises a plurality of detector tubes alternately connected to two or more detection channels, and wherein the two or more detection channels are analyzed using cross-correlation to make velocity, charge, and mass measurements of an analyte ion.

The apparatus of any preceding or following implementation, wherein the SPEeD mass analyzer stage comprises a plurality of detector tubes alternately connected to two detection channels; and wherein one of the two detection channels is inverted; and wherein the inverted and non-inverted channels are connected to the inputs of a differential amplifier to yield an increase signal-to-noise ratios and to greatly decrease common mode noise.

The apparatus of any preceding or following implementation, wherein the SPEeD mass analyzer stage comprises a plurality of detector tubes wherein one or more detection channels are analyzed using short-time Fourier transform (STFT) methods to make ion velocity, charge, and mass measurements of an analyte ion.

The apparatus of any preceding or following implementation, wherein the SPEeD mass analyzer stage comprises a plurality of detector tubes wherein one or more detection channels are analyzed using filter diagonalization methods to make ion velocity, charge, and mass measurements of an analyte ion.

A sequential pass express charge (e) detection (SPEeD) mass analyzer apparatus, comprising: (a) an inlet configured to receive a flow of ionized sample analytes; (b) an ion funnel stage downstream of the inlet, the ion funnel stage configured for desolvation and thermalization of the ionized analytes; (c) a quadrupole stage downstream of ion funnel stage, the quadrupole stage configured for thermalization and transport of the ionized analytes; (d) an ion accelerator stage downstream of the quadrupole, the ion accelerator stage configured for kinematic compression of the ionized analytes; and (e) a SPEeD mass analyzer stage downstream of the ion accelerator stage, the SPEeD mass analyzer stage configured for high-speed characterization of the ionized analytes.

The apparatus of any preceding or following implementation, wherein the analytes are selected from the group consisting of molecules, molecular assemblies, particles, intact cells, and other large analytes.

The apparatus of any preceding or following implementation, wherein the sample is ionized by a method for producing a distribution of highly charged analytes selected from the group consisting of electrospray ionization (ESI), extractive ESI (ESSI), desorption ESI (DESI), cold plasma ionization, sonic spray ionization, paper spray ionization, thermospray ionization, ultraviolet (UV) photoionization, and other ionization techniques.

The apparatus of any preceding or following implementation, wherein the SPEeD mass analyzer stage comprises a plurality of detector tubes alternately connected to two or more detection channels, and wherein the two or more detection channels are analyzed using cross-correlation to make velocity, charge, and mass measurements of an analyte ion.

The apparatus of any preceding or following implementation, wherein the SPEeD mass analyzer stage comprises a plurality of detector tubes alternately connected to two detection channels; and wherein one of the two detection channels is inverted; and wherein the inverted and non-inverted channels are connected to the inputs of a differential amplifier to yield an increase signal-to-noise ratios and to greatly decrease common mode noise.

The apparatus of any preceding or following implementation, wherein the SPEeD mass analyzer stage comprises a plurality of detector tubes wherein one or more detection channels are analyzed using short-time Fourier transform (STFT) methods to make ion velocity, charge, and mass measurements of an analyte ion.

The apparatus of any preceding or following implementation, wherein the SPEeD mass analyzer stage comprises a plurality of detector tubes wherein one or more detection channels are analyzed using filter diagonalization methods to make ion velocity, charge, and mass measurements of an analyte ion.

A method for sequential pass express charge (e) (SPEeD) detection, the method comprising: (a) producing a flow of ionized sample analytes; (b) introducing ionized sample analytes to an inlet configured to receive a flow of ionized sample analytes; (c) desolvating and thermalizing the ionized sample analytes; (d) kinematically compressing the desolvated and thermalized sample analytes; and (e) characterizing the kinematically compressed sample analytes with a SPEeD mass analyzer.

The method of any preceding or following implementation, wherein the sample is ionized by a method for producing a distribution of highly charged analytes selected from the group consisting of electrospray ionization (ESI), extractive ESI (ESSI), desorption ESI (DESI), cold plasma ionization, sonic spray ionization, paper spray ionization, thermospray ionization, and ultraviolet (UV) photoionization.

The method of any preceding or following implementation, further comprising: desolvating and thermalizing the ionized sample analytes with an ion funnel prior to kinematic compression.

The method of any preceding or following implementation, further comprising: desolvating and thermalizing the ionized sample analytes with a quadrupole prior to kinematic compression.

The method of any preceding or following implementation, further comprising: desolvating and thermalizing the ionized sample analytes with an ion funnel and a quadrupole prior to kinematic compression.

The method of any preceding or following implementation, further comprising: positively identifying an analyte ion using a SPEeD mass analyzer stage comprising a plurality of detector tubes alternately connected to two or more detection channels, the method comprising analyzing two or more detection channels using cross-correlation to make velocity, charge, and mass measurements of an analyte ion.

The method of any preceding or following implementation, further comprising: increased signal-to-noise ratios and greatly decreased common mode noise using a SPEeD mass analyzer stage comprising a plurality of detector tubes alternately connected to two detection channels, the method comprising analyzing two detection channels; wherein one of the two detection channels is inverted; and wherein the inverted and non-inverted channels are connected to the inputs of a differential amplifier to yield an increase signal-to-noise ratios and to greatly decrease common mode noise.

The method of any preceding or following implementation, further comprising: ion velocity, charge, and mass measurements made using a SPEeD mass analyzer stage comprising a plurality of detector tubes connected to one or more detection channels, the method comprising analyzing the one or more detection channels using short-time Fourier transform (STFT) methods to make ion velocity, charge, and mass measurements of an analyte ion.

The method of any preceding or following implementation, further comprising: ion velocity, charge, and mass measurements made using a SPEeD mass analyzer stage comprising a plurality of detector tubes connected to one or more detection channels, the method comprising analyzing the one or more detection channels using filter diagonalization methods to make ion velocity, charge, and mass measurements of an analyte ion.

As used herein, the term “implementation” is intended to include, without limitation, embodiments, examples, or other forms of practicing the technology described herein.

As used herein, the singular terms “a,” “an,” and “the” may include plural referents unless the context clearly dictates otherwise. Reference to an object in the singular is not intended to mean “one and only one” unless explicitly so stated, but rather “one or more.”

Phrasing constructs, such as “A, B and/or C”, within the present disclosure describe where either A, B, or C can be present, or any combination of items A, B and C. Phrasing constructs indicating, such as “at least one of” followed by listing a group of elements, indicates that at least one of these group elements is present, which includes any possible combination of the listed elements as applicable.

References in this disclosure referring to “an embodiment”, “at least one embodiment” or similar embodiment wording indicates that a particular feature, structure, or characteristic described in connection with a described embodiment is included in at least one embodiment of the present disclosure. Thus, these various embodiment phrases are not necessarily all referring to the same embodiment, or to a specific embodiment which differs from all the other embodiments being described. The embodiment phrasing should be construed to mean that the particular features, structures, or characteristics of a given embodiment may be combined in any suitable manner in one or more embodiments of the disclosed apparatus, system or method.

As used herein, the term “set” refers to a collection of one or more objects. Thus, for example, a set of objects can include a single object or multiple objects.

Relational terms such as first and second, top and bottom, upper and lower, left and right, and the like may be used solely to distinguish one entity or action from another entity or action without necessarily requiring or implying any actual such relationship or order between such entities or actions.

The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element.

As used herein, the terms “approximately”, “approximate”, “substantially”, “essentially”, and “about”, or any other version thereof, are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, “substantially” aligned can refer to a range of angular variation of less than or equal to ±10°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

The term “coupled” as used herein is defined as connected, although not necessarily directly and not necessarily mechanically. A device or structure that is “configured” in a certain way is configured in at least that way, but may also be configured in ways that are not listed.

Benefits, advantages, solutions to problems, and any element(s) that may cause any benefit, advantage, or solution to occur or become more pronounced are not to be construed as a critical, required, or essential features or elements of the technology describes herein or any or all the claims.

In addition, in the foregoing disclosure various features may be grouped together in various embodiments for the purpose of streamlining the disclosure. This method of disclosure is not to be interpreted as reflecting an intention that the claimed embodiments require more features than are expressly recited in each claim. Inventive subject matter can lie in less than all features of a single disclosed embodiment.

The abstract of the disclosure is provided to allow the reader to quickly ascertain the nature of the technical disclosure. It is submitted with the understanding that it will not be used to interpret or limit the scope or meaning of the claims.

It will be appreciated that the practice of some jurisdictions may require deletion of one or more portions of the disclosure after that application is filed. Accordingly the reader should consult the application as filed for the original content of the disclosure. Any deletion of content of the disclosure should not be construed as a disclaimer, forfeiture or dedication to the public of any subject matter of the application as originally filed.

The following claims are hereby incorporated into the disclosure, with each claim standing on its own as a separately claimed subject matter.

Although the description herein contains many details, these should not be construed as limiting the scope of the disclosure but as merely providing illustrations of some of the presently preferred embodiments. Therefore, it will be appreciated that the scope of the disclosure fully encompasses other embodiments which may become obvious to those skilled in the art.

All structural and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

What is claimed is:

1. A sequential pass express charge (e) detection (SPEeD) mass analyzer apparatus, comprising:
(a) an inlet configured to receive a flow of ionized sample analytes;
(b) an ion accelerator stage downstream of the inlet, said ion accelerator stage configured for kinematic compression of the ionized analytes; and
(c) a SPEeD mass analyzer stage downstream of the ion accelerator stage, said SPEeD mass analyzer stage configured for high-speed characterization of the ionized analytes.

2. The apparatus of claim 1, wherein the sample is ionized by a method for producing a distribution of highly charged analytes selected from the group consisting of electrospray ionization (ESI), extractive ESI (ESSI), desorption ESI (DESI), cold plasma ionization, sonic spray ionization, paper spray ionization, thermospray ionization, and ultraviolet (UV) photoionization.

3. The apparatus of claim 1, wherein the analytes are selected from the group consisting of molecules, molecular assemblies, particles, intact cells, and other large analytes.

4. The apparatus of claim 1, further comprising an ion funnel stage downstream of the inlet and upstream of the ion accelerator stage, said ion funnel stage configured for desolvation and thermalization of the ionized analytes.

5. The apparatus of claim 1, further comprising a quadrupole stage downstream of the ion the inlet and upstream of the ion accelerator stage, said quadrupole stage configured for thermalization and transport of the ionized analytes.

6. The apparatus of claim 1, further comprising:
an ion funnel stage downstream of the inlet and upstream of the ion accelerator stage, said ion funnel stage configured for desolvation and thermalization of the ionized analytes; and
a quadrupole stage downstream of the inlet and upstream of the ion accelerator stage, said quadrupole stage configured for thermalization and transport of the ionized analytes.

7. The apparatus of claim 1, wherein the SPEeD mass analyzer stage comprises a plurality of detector tubes alternately connected to two or more detection channels, and wherein the two or more detection channels are analyzed using cross-correlation to make velocity, charge, and mass measurements of an analyte ion.

8. The apparatus of claim 1, wherein the SPEeD mass analyzer stage comprises a plurality of detector tubes alternately connected to two detection channels; and
wherein one of the two detection channels is inverted; and
wherein the inverted and non-inverted channels are connected to the inputs of a differential amplifier to yield an increase signal-to-noise ratio and to greatly decrease common mode noise.

9. The apparatus of claim 1, wherein the SPEeD mass analyzer stage comprises a plurality of detector tubes wherein one or more detection channels are analyzed using short-time Fourier transform (STFT) analysis methods to make ion velocity, charge, and mass measurements of an analyte ion.

10. The apparatus of claim 1, wherein the SPEeD mass analyzer stage comprises a plurality of detector tubes wherein one or more detection channels are analyzed using filter diagonalization analysis methods to make ion velocity, charge, and mass measurements of an analyte ion.

11. A sequential pass express charge (e) detection (SPEeD) mass analyzer apparatus, comprising:
(a) an inlet configured to receive a flow of ionized sample analytes;
(b) an ion funnel stage downstream of the inlet, said ion funnel stage configured for desolvation and thermalization of the ionized analytes;
(c) an ion accelerator stage downstream of the ion funnel stage, said ion accelerator stage configured for kinematic compression of the ionized analytes; and
(d) a SPEeD mass analyzer stage downstream of the ion accelerator stage, said SPEeD mass analyzer stage configured for high-speed characterization of the ionized analytes.

12. The apparatus of claim 11, wherein the sample is ionized by a method for producing a distribution of highly charged analytes selected from the group consisting of electrospray ionization (ESI), extractive ESI (ESSI), desorption ESI (DESI), cold plasma ionization, sonic spray ionization, paper spray ionization, thermospray ionization, and ultraviolet (UV) photoionization.

13. The apparatus of claim 11, wherein the SPEeD mass analyzer stage comprises a plurality of detector tubes alternately connected to two or more detection channels, and wherein the two or more detection channels are analyzed using cross-correlation to make velocity, charge, and mass measurements of an analyte ion.

14. The apparatus of claim 11, wherein the SPEeD mass analyzer stage comprises a plurality of detector tubes alternately connected to two detection channels; and
wherein one of the two detection channels is inverted; and
wherein the inverted and non-inverted channels are connected to the inputs of a differential amplifier to yield an increase signal-to-noise ratios and to greatly decrease common mode noise.

15. The apparatus of claim 11, wherein the SPEeD mass analyzer stage comprises a plurality of detector tubes wherein one or more detection channels are analyzed using short-time Fourier transform (STFT) methods to make ion velocity, charge, and mass measurements of an analyte ion.

16. The apparatus of claim 11, wherein the SPEeD mass analyzer stage comprises a plurality of detector tubes wherein one or more detection channels are analyzed using filter diagonalization methods to make ion velocity, charge, and mass measurements of an analyte ion.

17. A sequential pass express charge (e) detection (SPEeD) mass analyzer apparatus, comprising:
(a) an inlet configured to receive a flow of ionized sample analytes;
(b) an ion funnel stage downstream of the inlet, said ion funnel stage configured for desolvation and thermalization of the ionized analytes;
(c) a quadrupole stage downstream of ion funnel stage, said quadrupole stage configured for thermalization and transport of the ionized analytes;
(d) an ion accelerator stage downstream of the quadrupole, said ion accelerator stage configured for kinematic compression of the ionized analytes; and
(e) a SPEeD mass analyzer stage downstream of the ion accelerator stage, said SPEeD mass analyzer stage configured for high-speed characterization of the ionized analytes.

18. The apparatus of claim 17, wherein the analytes are selected from the group consisting of molecules, molecular assemblies, particles, and intact cells.

19. The apparatus of claim 17, wherein the sample is ionized by a method for producing a distribution of highly charged analytes selected from the group consisting of electrospray ionization (ESI), extractive ESI (ESSI), desorption ESI (DESI), cold plasma ionization, sonic spray ionization, paper spray ionization, thermospray ionization, ultraviolet (UV) photoionization, and other ionization techniques.

20. The apparatus of claim 17, wherein the SPEeD mass analyzer stage comprises a plurality of detector tubes alternately connected to two or more detection channels, and wherein the two or more detection channels are analyzed using cross-correlation to make velocity, charge, and mass measurements of an analyte ion.

21. The apparatus of claim 17, wherein the SPEeD mass analyzer stage comprises a plurality of detector tubes alternately connected to two detection channels; and
wherein one of the two detection channels is inverted; and
wherein the inverted and non-inverted channels are connected to the inputs of a differential amplifier to yield an increase signal-to-noise ratios and to greatly decrease common mode noise.

22. The apparatus of claim 17, wherein the SPEeD mass analyzer stage comprises a plurality of detector tubes wherein one or more detection channels are analyzed using short-time Fourier transform (STFT) methods to make ion velocity, charge, and mass measurements of an analyte ion.

23. The apparatus of claim 17, wherein the SPEeD mass analyzer stage comprises a plurality of detector tubes wherein one or more detection channels are analyzed using filter diagonalization methods to make ion velocity, charge, and mass measurements of an analyte ion.

24. A method for sequential pass express charge (e) (SPEeD) detection, the method comprising:
(a) producing a flow of ionized sample analytes;
(b) introducing ionized sample analytes to an inlet configured to receive a flow of ionized sample analytes;
(c) desolvating and thermalizing the ionized sample analytes;
(d) kinematically compressing the desolvated and thermalized sample analytes; and
(e) characterizing the kinematically compressed sample analytes with a SPEeD mass analyzer.

25. The method of claim 24, wherein the sample is ionized by a method for producing a distribution of highly charged analytes selected from the group consisting of electrospray ionization (ESI), extractive ESI (ESSI), desorption ESI (DESI), cold plasma ionization, sonic spray ionization, paper spray ionization, thermospray ionization, and ultraviolet (UV) photoionization.

26. The method of claim 24, further comprising:
desolvating and thermalizing the ionized sample analytes with an ion funnel prior to kinematic compression.

27. The method of claim 24, further comprising:
desolvating and thermalizing the ionized sample analytes with a quadrupole prior to kinematic compression.

28. The method of claim 24, further comprising:
desolvating and thermalizing the ionized sample analytes with an ion funnel and a quadrupole prior to kinematic compression.

29. The method of claim 24, further comprising:
providing a SPEeD mass analyzer stage comprising a plurality of detector tubes alternately connected to two or more detection channels, and analyzing two or more detection channels using cross-correlation to make velocity, charge, and mass measurements of an analyte ion.

30. The method of claim 24, further comprising:
providing a SPEeD mass analyzer stage comprising a plurality of detector tubes alternately connected to two detection channels wherein one of the two detection channels is inverted; and
analyzing the two detection channels;
wherein the inverted and non-inverted channels are connected to the inputs of a differential amplifier to yield an increase signal-to-noise ratios and to greatly decrease common mode noise.

31. The method of claim 24, further comprising:
providing a SPEeD mass analyzer stage comprising a plurality of detector tubes connected to one or more detection channels; and
analyzing the one or more detection channels using short-time Fourier transform (STFT) methods to make ion velocity, charge, and mass measurements of an analyte ion.

32. The method of claim 24, further comprising:
providing a SPEeD mass analyzer stage comprising a plurality of detector tubes connected to one or more detection channels; and
analyzing the one or more detection channels using filter diagonalization methods to make ion velocity, charge, and mass measurements of an analyte ion.
